(19) United States
(12) Patent Application Publication
(10) Pub. No.: US 2012/0144968 A1
(43) Pub. Date: Jun. 14, 2012

(54) CLAMPING TOOL FOR USE IN MANUFACTURING FOOT ORTHOSIS SUPPORT DEVICES

(75) Inventors: Peter K. Battersby, Lynden, WA (US); Noah C. Wass, Ferndale, WA (US)

(73) Assignee: Cascade Dafo, Inc, Ferndale, WA (US)

(21) Appl. No.: 12/963,925

(22) Filed: Dec. 9, 2010

(51) Int. Cl. B26D 7/02; B25B 11/00; B23Q 3/08

(52) U.S. Cl. 83/13; 269/218; 83/452; 29/559

(57) ABSTRACT

A clamping device and associated method for clamping a foam carving block for use by a carving system to produce a positive mold during the manufacturing of orthotic and prosthetic devices. The clamping device includes first and second elongated clamping jaws that are selectively movable between an opened position and a closed position, wherein the clamping jaws clamp the foam carving block therebetween when in the closed position. The clamping device is further operative to automatically center the foam carving block when the foam carving block is clamped. The clamping device also includes a mechanism for automatically generating indexing holes in the foam carving block for use in subsequent manufacturing processes for the orthotic or prosthetic devices.

### BACKGROUND

1. Field

The present embodiments are directed to improvements for the manufacturing of orthotic and prosthetic devices, and more particularly, to tools for clamping a foam carving block for use by a carving system to produce a positive mold during the manufacturing of orthotic and prosthetic devices.

2. Related Art

The following description includes information that may be useful in understanding the present invention. It is not an admission that any of the information provided herein is prior art or relevant to the presently claimed invention, or that any publication specifically or implicitly referenced is prior art. Below is a general description of a process for designing and manufacturing orthotic devices. As can be appreciated, the present invention may be applicable to the design and manufacturing of prosthetic devices as well.

When designing and manufacturing a particular orthotic device, a podiatrist may first scan a portion of the foot of a patient for which the orthotic device is intended. The scan may measure the topography of the portion of the foot and may allow the podiatrist to develop a three-dimensional model of the patient's foot. Alternatively, a podiatrist may form a positive or negative cast of a portion of the patient's foot and may then forward the cast to a laboratory for both scanning and preparing of the orthotic device. In this way, podiatrists without access to a scanner in the office may still benefit from the information provided by an optical scan. In other cases, a podiatrist may form a positive or negative cast and scan the formed cast in their office. As with scanning the foot directly, the podiatrist may then forward the information about the portion of the foot to a laboratory specializing in the making of orthotic devices.

The laboratory may convert the data received from the podiatrist into a three-dimensional mathematical model of the incorrect or corrected portions of the foot. For example, the model may include a corrected portion of the foot as well as a desired orthotic device positioned on the foot. The laboratory may then take the data and carve out a positive mold from a foam block, wherein the resulting positive mold has the shape of the corrected foot/orthotic device combination.

Following the carving of the positive mold, an orthotic material may be formed over the mold using a vacuum thermoforming or other suitable process. The vacuum thermoforming generally involves first heating the orthotic material in an oven and then placing the heated material in an evacuated chamber with the positive mold until the orthotic material conforms to the shape of the mold. After the thermoforming process, a milling machine may be used to cut and trim the orthotic material to its desired shape and size.

Foam blocks, such as polyurethane foam blocks, of various shapes and sizes are typically used to produce three-dimensional positive molds for use in the orthotic devices. To produce these molds, the foam blocks are generally mounted on a mandrel which is then fitted into a numerically (or computer) controlled carving machine. The mandrel may be rotated while the carving tool controlled by the machine's computer is moved in predetermined manner relative to the mandrel to carve out the predetermined shape for the positive mold. Often, it can be difficult to mount and dismount the foam carving blocks from the mandrel. Further, it is also possible to mount the foam blocks in more than one angular orientation relative to the mandrel, which is undesirable since this may cause the resulting positive mold to have an undesirable shape or texture.

### BRIEF DESCRIPTION OF THE DRAWINGS

FIG. 1 is a front-left perspective view of a carving system that includes an exemplary clamping device.

FIG. 2 is a front-right perspective view of the carving system shown in FIG. 1, wherein the clamping device has been rotated by 90 degrees.

FIG. 3A is a top view of the clamping device when its clamping jaws are positioned in the opened position.

FIG. 3B is a bottom view of the clamping device when the clamping jaws are positioned in the opened position.

FIG. 4A is a top view of the clamping device when the clamping jaws are positioned in the closed position.

FIG. 4B is a bottom view of the clamping device when the clamping jaws are positioned in the closed position.

FIG. 5A is a top-right perspective view of the clamping device when the clamping jaws are positioned in the opened position.

FIG. 5B is a bottom-right perspective view of the clamping device when the clamping jaws are positioned in the opened position.

FIG. 6A is a top-right perspective view of the clamping device when the clamping jaws are positioned in the closed position.

FIG. 6B is a bottom-right perspective view of the clamping device when the clamping jaws are positioned in the closed position.

### DETAILED DESCRIPTION

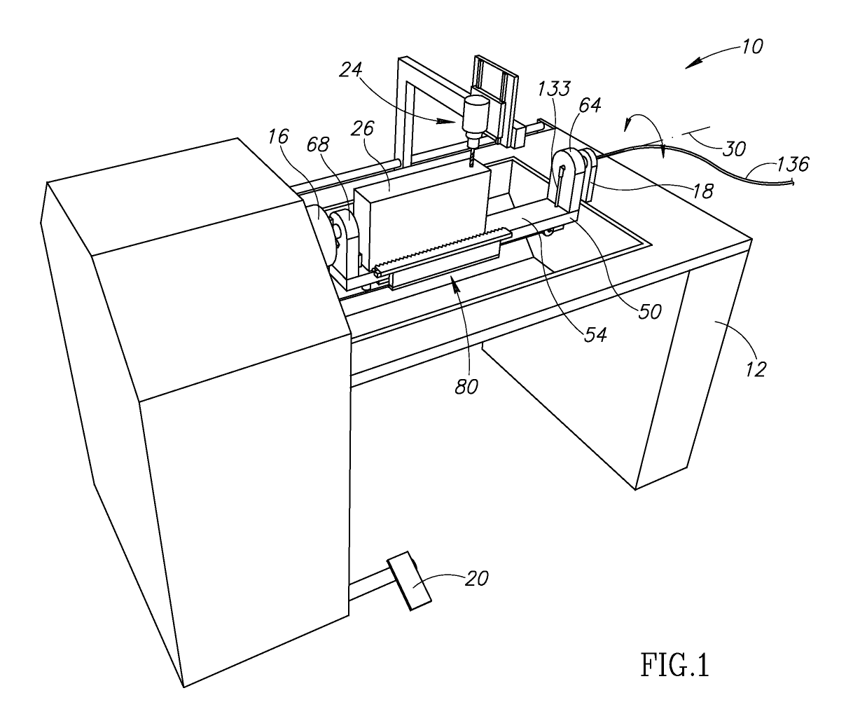

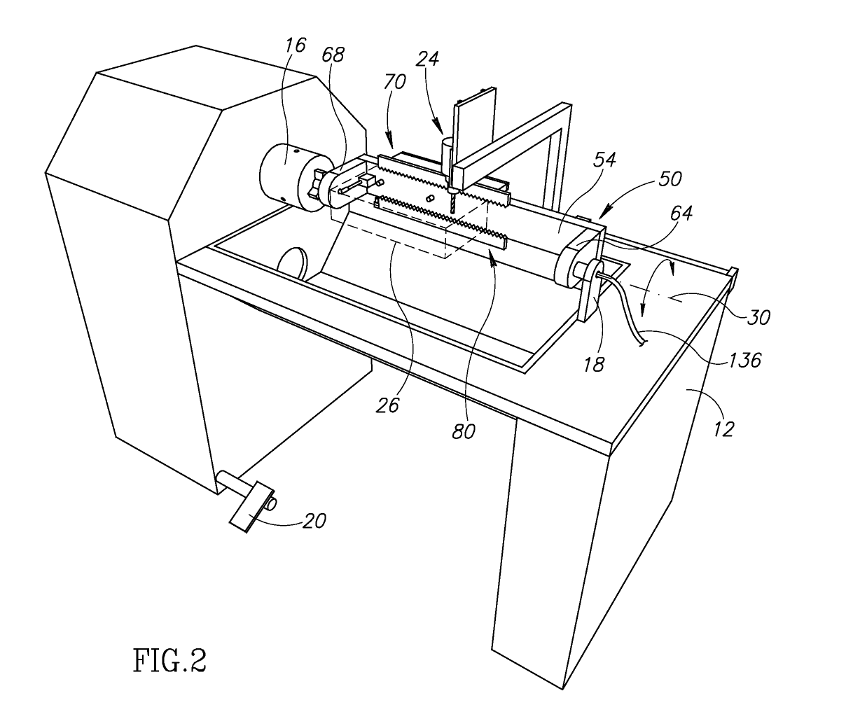

Referring to FIGS. 1 and 2, there is shown a carving system 10 for carving a foam block 26 (e.g., polyurethane foam, or the like) into a positive mold for use in the manufacturing of an orthotic or prosthetic device. The carving system 10 includes a mounting table 12, a carving tool 24 (e.g., a computer numerical controlled carver), and a clamping device 50 for securing the foam block 26. As discussed below, the clamping device 50 is attached to the table 12 through a rotary coupling, such that the clamping device 50 may rotate about a rotation axis 30, which allows the carving tool 24 to carve the foam block 26 on more than one side. The table 12 includes a rotary head 16 that is operative to rotate the clamping device 50 as desired. As can be appreciated, the rotary head 16 may be communicatively coupled to a computer (not shown) operative to control the rotation of the rotary head and therefore the rotation of the clamping device 50.

As shown in FIGS. 1 and 2, the foam block 26 is positioned on the top surface of a base 54 of the clamping device 50 and securely clamped between a first clamping jaw 70 and a second clamping jaw 80. The carving system 10 further includes a pedal 20 configured to control the operation of the first and second clamping jaws 70 and 80 of the clamping device 50, so that the foam block 26 may be selectively clamped and released by a user.

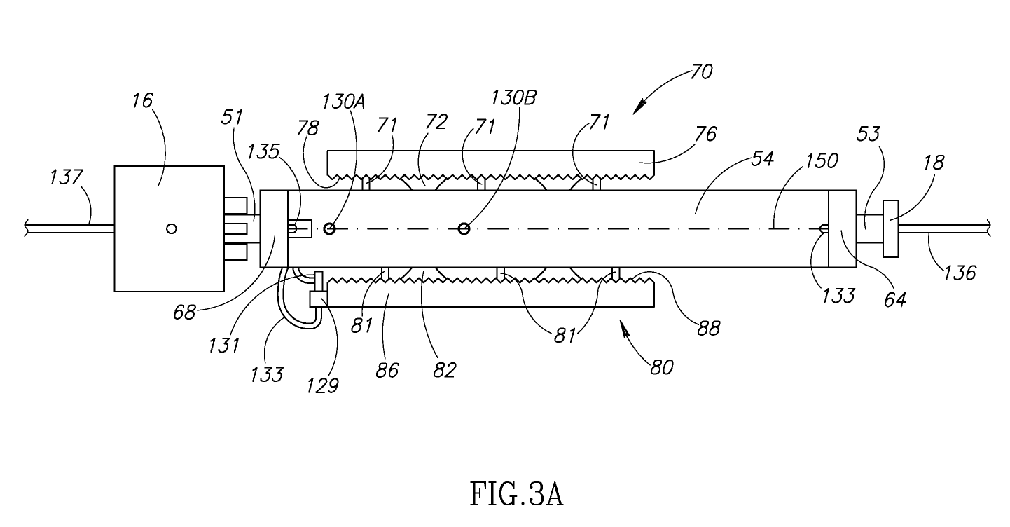

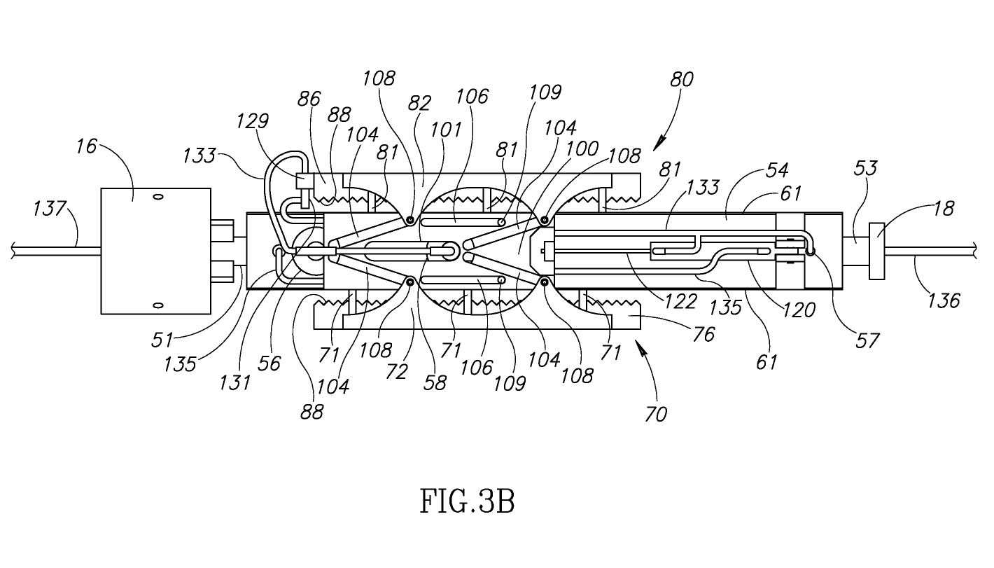

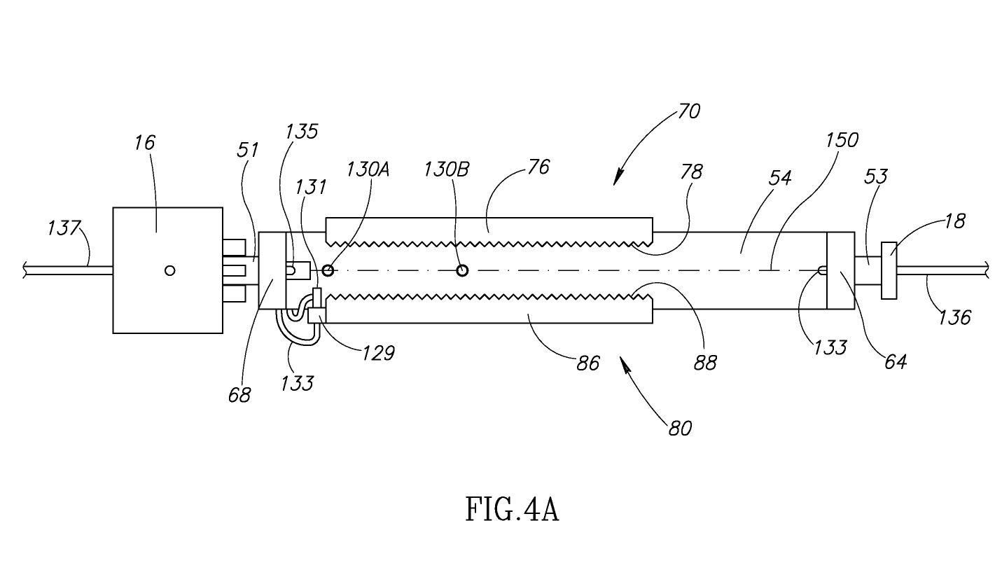

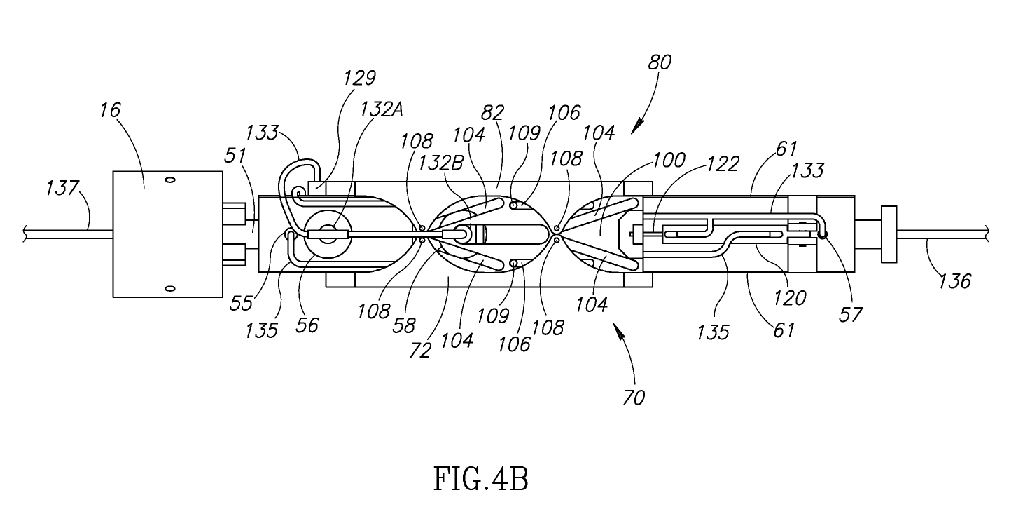

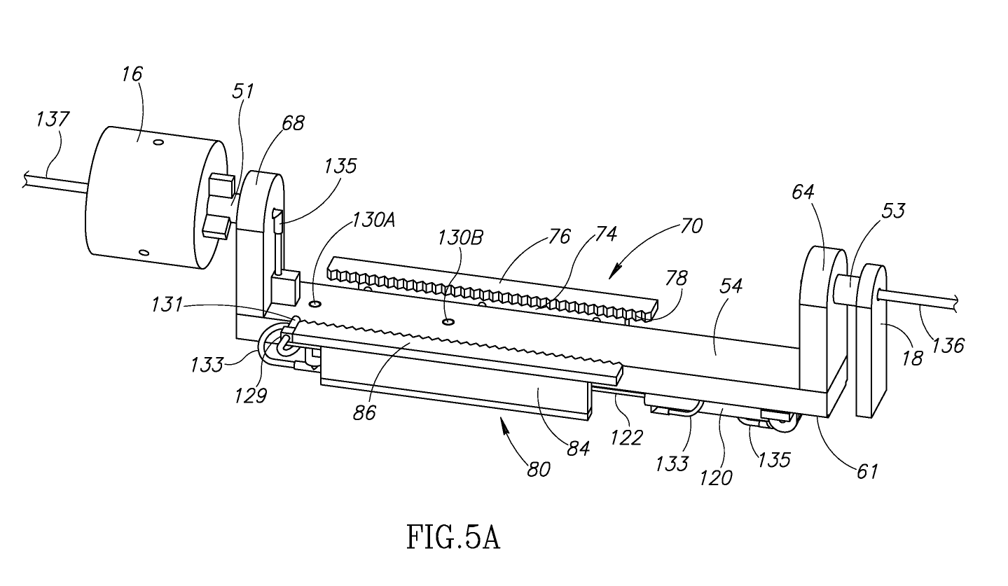

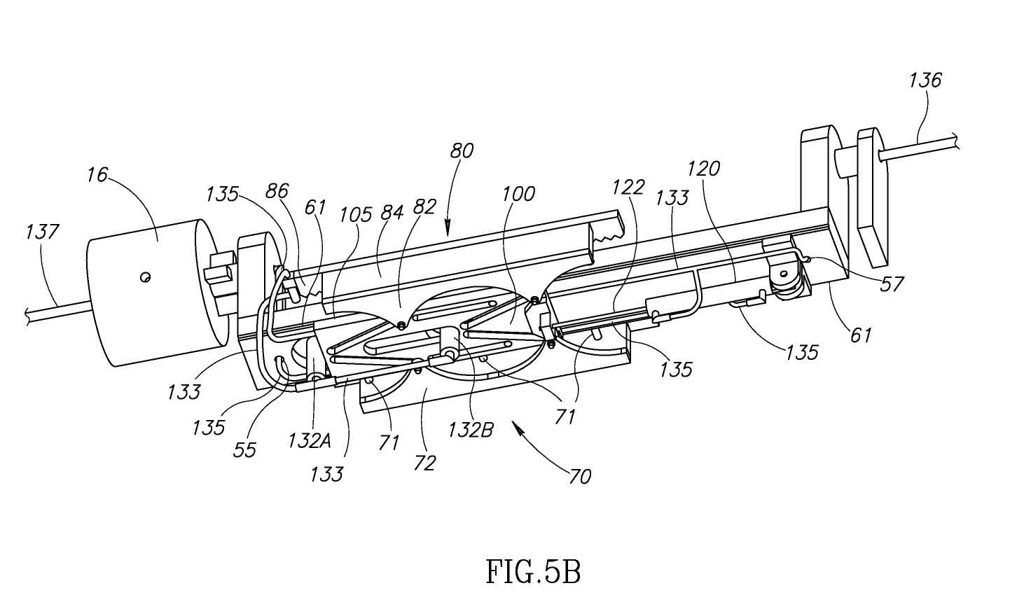

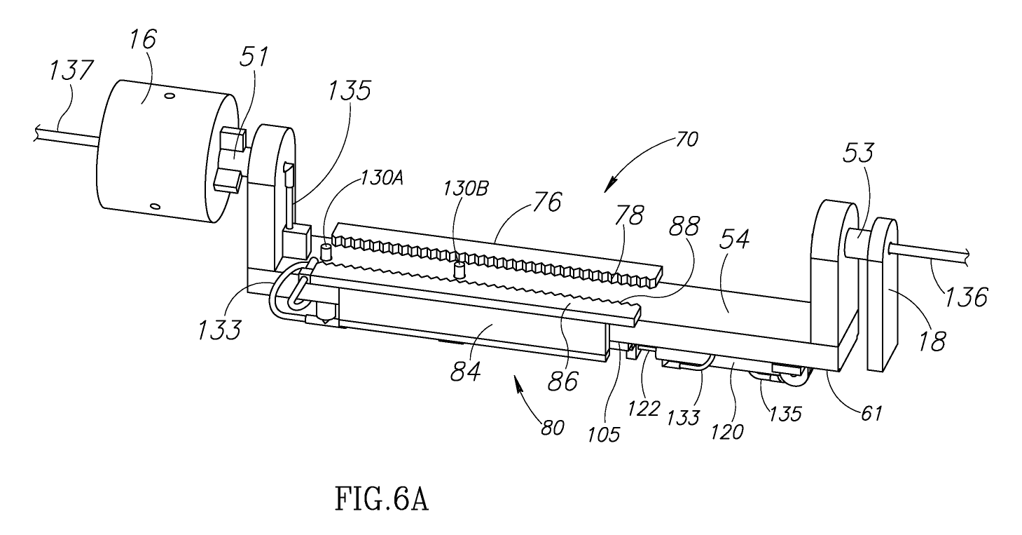

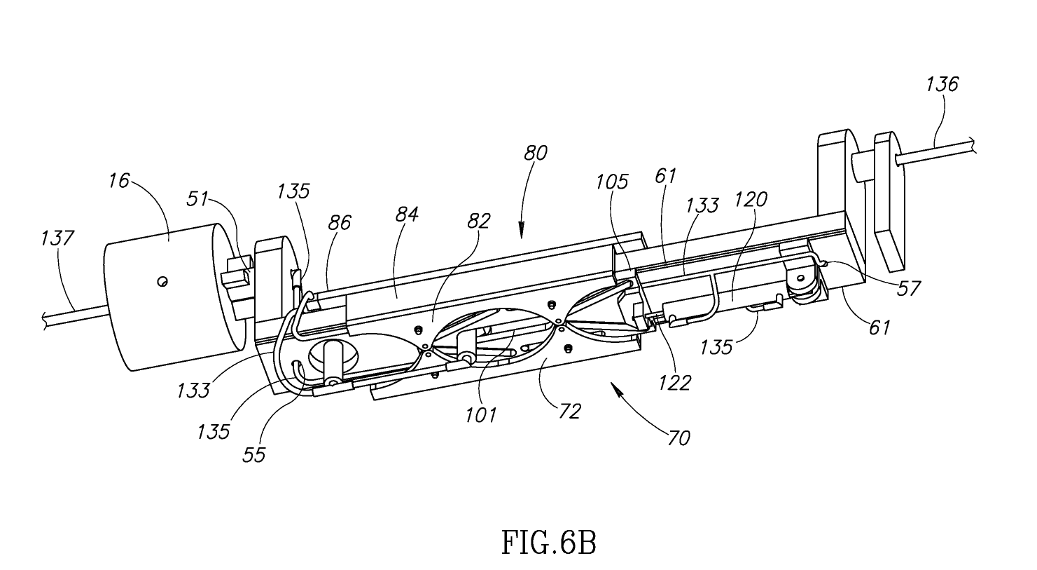

In operation, the clamping jaws 70 and 80 may be positioned in a closed position, wherein the clamping jaws are in a relatively laterally inward position (see FIGS. 4A-4B and 6A-B). A user may actuate the pedal 20, which causes the clamping jaws 70 and 80 to move laterally outward into an opened position wherein the clamping jaws 70 and 80 are in a relatively laterally outward position (see FIGS. 3A, 3B, 5A and 5B). The user may then place the foam block 26 on the base 54 of the clamping device 50 and between the first and second clamping jaws 70 and 80 when the first and second clamping jaws are in the opened position. Next, the user may release the pedal 20, which causes the clamping jaws 70 and 80 to move from the opened position toward each other to the closed position, such that the foam block 26 is grasped between the clamping jaws and hence securely fixed relative to the clamping device 50. Once the foam block 26 has been securely clamped to the clamping device 50, the position of the foam block 26 may be rotated (see FIG. 2) so that the carving tool 24 may have access to multiple sides of the foam block 26. In this manner, the carving tool 24 may then cut the foam block 26 into a positive mold. Further, once the positive mold has been carved out of the foam block 26 using the carving tool 24, a user may once again actuate the pedal 20 to cause the clamping jaws 70 and 80 to move into the opened position so that the block may be removed and used in further manufacturing processes.

Various views of the clamping device 50 are shown in FIGS. 3A-B, 4A-B, 5A-B, and 6A-B. As noted above, FIGS. 3A-B and 5A-B illustrate the clamping device 50 when the clamping jaws 70 and 80 are in the opened position. Similarly, FIGS. 4A-B and 6A-B illustrate the clamping device 50 when the clamping jaws 70 and 80 are in the closed position. For illustration purposes, the foam block 26 is not shown in FIGS. 3 through 6.

The base 54 of the clamping device 50 includes shaft coupling portions 64, 68 positioned at each end of the top surface of the base and extending transverse to the base. The shaft coupling portions 64, 68 are further attached to shafts 53 and 51, respectively, which are mounted to the table 12 via a shaft support 18 and the rotary head 16, respectively.

The first clamping jaw 70 includes a clamping portion 76 having a plurality of teeth 78 on an inward side thereof configured to grip the foam block 26 during use. The clamping jaw 70 further includes a guide portion 74 (see FIG. 5A) coupled to the clamping portion 76. The guide portion 74 includes three guide pins 71 (see FIG. 3A) that extend into apertures positioned on the side of the base 54 and are slidably received therein. In operation, as the clamping jaw 70 is moved laterally inward and outward relative to the base 54, the guide pins 71 slide within the apertures on the side of the base 54 and function to confine the clamping jaw 70 to laterally inward and outward movement. The clamping jaw 70 also includes a coupling portion 72 configured to couple with an actuating plate 100 (see FIG. 3B), which is described below.

The second clamping jaw 80 may be substantially identical to the first clamping jaw 70, and includes a clamping portion 86 having a plurality of teeth 88 on an inward side thereof. The clamping jaw 80 also includes a guide portion 84 (see FIG. 5A) coupled to the clamping portion 86. The guide portion 84 includes three guide pins 81 (see FIG. 3A) that extend into and are slidably received in apertures positioned on the side of the base 54 opposite the side wherein the guide pins 71 are inserted. The guide pins 81 confine the clamping jaw 80 to laterally inward and outward movement. Like the clamping jaw 70, the clamping jaw 80 also includes a coupling portion 82 configured to couple with an actuating plate 100 (see FIG. 3B).

To open and close the clamping jaws 70 and 80, the clamping device 50 has an actuating mechanism that includes the actuating plate 100, which is slidably coupled to a bottom portion of the base 54 via guide pins 109 (see FIG. 3B) inserted into guide slots 106 of the actuating plate 100 (See FIG. 3B). The actuating plate 100 also includes longitudinally upwardly extending guide members 105 (see FIGS. 5B, 6A, and 6B) disposed on each of the two longitudinally extending sides and configured to slidably engage with corresponding guide shoulders 61 (see FIG. 6B) disposed on the base 54 such that lateral movement of the actuating plate is restrained. Further, to selectively slide the actuating plate 100 relative to the base 54, the actuating mechanism also includes a piston 122 and a pneumatic cylinder 120 coupled between the base 54 and the actuating plate 100. As can be appreciated, although the pneumatic cylinder 120 is provided in this embodiment, other suitable means for selectively sliding the actuating plate 100 may be used.

The clamping jaws 70 and 80 are also coupled to the actuating plate 100 by guide pins 108 (see FIG. 3B) inserted into angled guide slots 104. As may best be viewed in FIGS. 3B and 4B, as the actuating plate 100 moves from the opened position (shown in FIG. 3B) to the closed position (shown in FIG. 4B), the guide pins 108 slide along the angled guide slots 104 of the actuating plate 100, thereby simultaneously moving each of the clamping jaws 70 and 80 laterally inward into the closed position. Advantageously, the actuating plate 100 and the clamping jaws 70 and 80 are symmetric about a center line 150 of the base 54 (see FIG. 3A). In this regard, as the clamping jaws 70 and 80 are moved from the opened position to the closed position when the foam block 26 is supported on the base 54, the clamping jaws automatically center the foam block 26 along the center line 150 of the base 54. As can be appreciated, by automatically centering the foam block 26 on the center line 150, regardless of its particular size, the need for manual or computer controlled centering of the foam block is eliminated. Further, by utilizing elongated clamping jaws 70 and 80 that clamp the foam block 26 along its full length to retain the position of the foam block as compared to utilizing a mandrel inserted into the foam block 26, the clamping device 50 is able to rigidly fix the position of the foam block 26, which results in positive molds manufactured having a more smooth and consistent shape and texture.

To control the operation of the actuating plate 100, a pneumatic system comprising pneumatic tubing 133 and 135 is coupled to the cylinder 120 (see FIGS. 3B, 4B, 5B, and 6B). The pneumatic tubing 133 passes through an opening 57 in the base 54 and further passes through an opening in the shaft coupling portion 64 (see FIG. 1) to exit the clamping device 50. The pneumatic tubing 133 is then coupled to tubing 136 through the rotary coupling between the clamping device 50 and the shaft support 18. Similarly, the pneumatic tubing 135 passes through an opening 55 in the base 54 and further passes through an opening in the shaft coupling portion 68 to exit the clamping device 50. The pneumatic tubing 135 is then coupled to tubing 137 through the rotary coupling between the clamping device 50 and the rotary head 16. As can be appreciated, the tubing 136 and 137 may be coupled to a pressure generating device (e.g., a compressor) and valves that are selectively opened and closed by the pedal 20, such that the clamping jaws 70 and 80 may be selectively opened and closed by a user. Further, by utilizing a rotary coupling, the clamping device 50 may rotate freely without causing the tubing 133 and 135 to become tangled or twisted.

As best shown in FIGS. 5A and 6A, the clamping device 50 also includes two punch rods 130A and 130B positioned along the center line 150 of the base 54. In operation, the punch rods 130A and 130B are moveable between a first position wherein they are recessed or level with the top surface of the base 54 (shown in FIG. 5A), and a second position wherein they are protruding from the top surface of the base (shown in FIG. 6A). The punch rods 130A and 130B are movable from the first position to the second position with sufficient force to generate two indexing holes in the foam block 26 clamped between the clamping jaws 70 and 80. As can be appreciated, the indexing holes generated in the foam block 26 may be used in further steps in the manufacturing process for the orthotic device. For example, the indexing holes may be used to automatically position the positive mold formed from the foam block 26 within a vacuum thermoformer. As an additional example, the indexing holes may be used to automatically position a positive mold formed from block 26 into a machine used for trimming the resulting prosthetic material into a desired shape and size.

As may best be viewed in FIG. 5B, the punch rods 130A and 130B are disposed within punch rod housings 132A and 132B, respectively, which extend through and are slidably disposed in apertures 56 and 58 (see FIG. 4B), respectively, in the base 54. To prevent the actuating plate 100 from interfering with the punch rod housing 132B as it slides relative to the base 54, the actuating plate includes an elongate aperturate 101 sized to allow the punch rod housing 132B to avoid contact with the actuating plate during use.

Like the actuating plate 100, the punch rods 130A and 130B are activated using the pneumatic system comprising tubing 133 and 135 coupled to the punch rod housings 132A and 132B (see FIGS. 3B, 4B, 5B, and 6B). To control the activation of the punch rods 130A and 130B, the tubing 133 is coupled to a valve 129 that is selectively opened and closed by depressing a button 131 (See FIG. 4A). As shown, the button 131 protrudes inward slightly further than the teeth 88 of the clamping portion 86 of the clamping jaw 80. In this way, as the clamping jaws 70 and 80 move from the opened position toward the closed position and start to clamp the foam block 26 therebetween, the foam block is moved sufficiently toward the clamping portion 86 of the clamping jaw 80 to engage and depress the button 131, thereby opening the valve 129 and causing the punch rods 130 to move rapidly from their recessed position to the protruding position to punch the indexing holes into the foam block. Thus, the indexing holes are thereby automatically generated by the clamping device 50 as the clamping jaws 70 and 80 clamp the foam block 26 in place.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

The invention claimed is:

1. An apparatus for clamping a block while it is carved into a mold, comprising:
a base including a top surface configured to support the block when positioned thereon, the base further including a first side, a second side opposite the first side, and a center portion located midway between the first side and the second side and extending along a longitudinal center axis;
a first clamping jaw movably coupled to the base and positioned above the top surface of the base proximate the first side of the base, the first clamping jaw being configured for selective lateral movement between an opened position wherein the first clamping jaw is in a laterally outward position, and a closed position wherein the first clamping jaw is in a relatively laterally inward position;
a second clamping jaw movably coupled to the base and positioned above the top surface of the base proximate the second side of the base, the second clamping jaw being configured for selective lateral movement between an opened position wherein the second clamping jaw is in a laterally outward position, and a closed position wherein the second clamping jaw is in a relatively laterally inward position; and
an actuating mechanism coupled to the first clamping jaw and the second clamping jaw and operative to simultaneously move the first clamping jaw and the second clamping jaw between the opened position and the closed position, such that, when in the closed position, the first clamping jaw and the second clamping jaw clamp therebetween the block positioned on the top surface of the base, the actuating mechanism being coupled to the first clamping jaw and the second clamping jaw to move the first clamping jaw and the second clamping jaw in unison and at the same rate toward the longitudinal center axis of the center portion of the base to automatically center the block therebetween on the center portion of the base.

2. The apparatus of claim 1, wherein the actuating mechanism includes an actuating member which translates movement of the actuating member in a direction along the longitudinal center axis of the center portion of the base into lateral movement of the first clamping jaw and the second clamping jaw between the opened position and the closed position.

3. The apparatus of claim 2, wherein the actuating member is an actuating plate slidably coupled to the base, and slidably coupled to the first clamping jaw and the second clamping jaw, such that movement of the actuating plate in a direction along the longitudinal center axis of the center portion of the base relative to the base effects movement of the first clamping jaw and the second clamping jaw between the opened position and the closed position.

4. The apparatus of claim 3, wherein movement of the actuating plate in a first direction along the longitudinal center axis of the center portion of the base effects movement of the first clamping jaw and the second clamping jaw toward the opened position, and movement of the actuating plate in an opposite second direction along the longitudinal center axis of the center portion of the base effects movement of the first clamping jaw and the second clamping jaw toward the closed position.

5. The apparatus of claim 4, wherein the actuating plate includes a plurality of angled guide slots each configured to receive a guide pin, and wherein the first clamping jaw and the second clamping jaw include a plurality of guide pins that are each slidably disposed within one of the angled guide slots of the actuating plate.

6. The apparatus of claim 4, wherein the actuating plate includes at least two horizontal guide slots each configured to receive a guide pin, and wherein the base further comprises a bottom surface opposite the top surface having at least two guide pins thereon that are each slidably disposed within one of the horizontal guide slots of the actuating plate such that lateral movement of the actuating plate is restrained.

7. The apparatus of claim 4, wherein the actuating plate includes longitudinally upwardly extending guide members disposed on each of two longitudinally extending sides that are configured to slidably engage with corresponding guide shoulders disposed on the base such that lateral movement of the actuating plate is restrained.

8. The apparatus of claim 1, wherein the actuating mechanism comprises a pneumatic cylinder.

9. The apparatus of claim 1, wherein the actuating mechanism is operative to maintain the position of the first clamping jaw and the second clamping jaw at equal distances from the longitudinal center axis of the center portion of the base as the first clamping jaw and the second clamping jaw are moved between the opened position and the closed position.

10. The apparatus of claim 1, further comprising:
an index hole forming member coupled to the base and configured for movement between a first position wherein the index hole forming member does not extend outward beyond the top surface of the base, and a second position wherein the index hole forming member at least partially extends outward beyond the top surface of the base; and
an index hole forming member actuating mechanism configured to selectively move the index hole forming member between the first position and second position to create an indexing hole in the block positioned on the top surface of the base.

11. The apparatus of claim 10, wherein the index hole forming member is a punch rod.

12. The apparatus of claim 10, wherein the index hole forming member actuating mechanism comprises:
an actuator configured to activate the index hole forming member actuating mechanism when engaged, the actuator being coupled to one of the first clamping jaw and second clamping jaw and positioned such that the actuator is engaged by the block as the first clamping jaw and the second clamping jaw are moved from the open position to the closed position.

13. The apparatus of claim 10, wherein the index hole forming member actuating mechanism comprises a pneumatic cylinder.

14. The apparatus of claim 1, further comprising:
a first shaft coupled to a first longitudinal end of the base;
a second shaft coupled to a second longitudinal end of the base opposite the first longitudinal end;
wherein the first shaft and the second shaft are configured for rotational coupling with an apparatus support system such that the apparatus is selectively rotatable when coupled with the apparatus support system.

15. A carving system, comprising:
a carving tool configured to be computer controlled;
a mounting structure configured to support a clamping device; and
a clamping device coupled to the mounting structure and configured to be rotatable about a rotation axis, the clamping device comprising:
a base including a top surface configured to support the block when positioned thereon, the base further including a first side, a second side opposite the first side, and a center portion located midway between the first side and the second side and extending along a longitudinal center axis;
a first clamping jaw movably coupled to the base and positioned above the top surface of the base proximate the first side of the base, the first clamping jaw being configured for selective lateral movement between an opened position wherein the first clamping jaw is in a laterally outward position, and a closed position wherein the first clamping jaw is in a relatively laterally inward position;
a second clamping jaw movably coupled to the base and positioned above the top surface of the base proximate the second side of the base, the second clamping jaw being configured for selective lateral movement between an opened position wherein the second clamping jaw is in a laterally outward position, and a closed position wherein the second clamping jaw is in a relatively laterally inward position; and
an actuating mechanism coupled to the first clamping jaw and the second clamping jaw and operative to simultaneously move the first clamping jaw and the second clamping jaw between the opened position and the closed position, such that, when in the closed position, the first clamping jaw and the second clamping jaw clamp therebetween the block positioned on the top surface of the base, the actuating mechanism being coupled to the first clamping jaw and the second clamping jaw to move the first clamping jaw and the second clamping jaw in unison and at the same rate toward the longitudinal center axis of the center portion of the base to automatically center the block therebetween on the center portion of the base.

16. A method of forming a positive mold for use during manufacturing of an orthotic device, comprising:
proving a block;
providing a clamping device comprising:
a base including a top surface configured to support the block when positioned thereon, the base further including a first side, a second side opposite the first side, and a center portion located midway between the first side and the second side and extending along a longitudinal center axis;
a first clamping jaw movably coupled to the base and positioned above the top surface of the base proximate the first side of the base, the first clamping jaw being configured for selective lateral movement between an opened position wherein the first clamping jaw is in a laterally outward position, and a closed position wherein the first clamping jaw is in a relatively laterally inward position;
a second clamping jaw movably coupled to the base and positioned above the top surface of the base proximate the second side of the base, the second clamping jaw being configured for selective lateral movement between an opened position wherein the second clamping jaw is in a laterally outward position, and a closed position wherein the second clamping jaw is in a relatively laterally inward position; and
an actuating mechanism coupled to the first clamping jaw and the second clamping jaw and operative to simultaneously move the first clamping jaw and the second clamping jaw between the opened position and the closed position, such that, when in the closed position, the first clamping jaw and the second clamping jaw clamp therebetween the block positioned on the top surface of the base, the actuating mechanism being coupled to the first clamping jaw and the second clamping jaw to move the first clamping jaw and the second clamping jaw in unison and at the same rate toward the longitudinal center axis of the center portion of the base to automatically center the block therebetween on the center portion of the base;
positioning the block on the top surface of the base of the clamping device when the first clamping jaw and the second clamping jaw are in the opened position; and
activating the actuating mechanism to cause the first clamping jaw and the second clamping jaw to move laterally inward toward the closed position until the first clamping jaw and the second clamping jaw clamp the block in a fixed position therebetween.

17. The method of claim 16, wherein the activating comprises:
moving the actuating mechanism in a direction transverse to the direction of movement of the first clamping jaw and the second clamping jaw as the first clamping jaw and the second clamping jaw move from the opened position toward the closed position.

18. The method of claim 16, wherein the actuating mechanism comprises and actuating plate slidably coupled to the base and the first clamping jaw and the second clamping jaw, and wherein the activating comprises:
sliding the actuating plate relative to the base to effect movement of the first clamping jaw and the second clamping jaw toward the closed position.

19. The method of claim 16, wherein the clamping device further comprises an index hole forming member coupled to the base and configured for movement between a first position wherein the index hole forming member does not extend outward beyond the top surface of the base, and a second position wherein the index hole forming member at least partially extends outward beyond the top surface of the base; and an index hole forming member actuating mechanism configured to selectively move the index hole forming member between the first position and second position to create an indexing hole in the block positioned on the top surface of the base; the method further comprising:
activating the index hole forming member actuating mechanism to cause the index hole forming member to move to the second position and create an indexing hole in the block.

20. The method of claim 19, wherein the index hole forming member actuating mechanism comprises an actuator configured to activate the index hole forming member actuating mechanism when engaged, the actuator being coupled to one of the first clamping jaw and second clamping jaw and positioned such that the actuator is engaged by the block as the first clamping jaw and the second clamping jaw are moved from the open position to the closed position.

21. The method of claim 16, further comprising:
carving the block into a mold while the block is held in the fixed position between the first clamping jaw and the second clamping jaw.

22. The method of claim 16, further comprising:
activating the actuating mechanism to cause the first clamping jaw and the second clamping jaw to move laterally outward into the opened position wherein the first clamping jaw and the second clamping jaw release the block from the fixed position.

23. The method of claim 16, further comprising:
mounting the clamping device onto a clamping device support system such that the clamping device may be rotated about a rotation axis.

24. The method of claim 23, further comprising:
selectively rotating the clamping device about the rotation axis between a first rotational position and a second rotational position.

25. An apparatus for clamping a block while it is carved into a mold, comprising:
a base including a top surface configured to support the block when positioned thereon, the base further including a first side, a second side opposite the first side, and a center portion located midway between the first side and the second side and extending along a longitudinal center axis;
a first clamping jaw movably coupled to the base and positioned above the top surface of the base proximate the first side of the base, the first clamping jaw being configured for selective lateral movement between an opened position wherein the first clamping jaw is in a laterally outward position, and a closed position wherein the first clamping jaw is in a relatively laterally inward position;
a second clamping jaw movably coupled to the base and positioned above the top surface of the base proximate the second side of the base, the second clamping jaw being configured for selective lateral movement between an opened position wherein the second clamping jaw is in a laterally outward position, and a closed position wherein the second clamping jaw is in a relatively laterally inward position; and
an actuating mechanism coupled to the first clamping jaw and the second clamping jaw and operative to simultaneously move the first clamping jaw and the second clamping jaw between the opened position and the closed position, such that, when in the closed position, the first clamping jaw and the second clamping jaw clamp therebetween the block positioned on the top surface of the base.
